(19) United States
(12) Patent Application Publication
(10) Pub. No.: US 2012/0050096 A1
(43) Pub. Date: Mar. 1, 2012

(54) GLONASS Bit Boundary Detection

(76) Inventors: Hao-Ren Cheng, Yuanli Township (TW); Qinfang Sun, Cupertino, CA (US); Hao Zhou, Mountain View, CA (US); Gaspar Lee, Bade City (TW)

(21) Appl. No.: 12/870,533

(22) Filed: Aug. 27, 2010

(51) Int. Cl. G01S 19/42

(52) U.S. Cl. 342/357.25

(57) ABSTRACT

A method of determining a bit boundary of a GLONASS string is provided. In this method, a global position receiver can remove the meander sequence from bits of a GLONASS signal. After removing the meander sequence, time averages of bit energies for 20 possible (consecutive) bit boundary positions can be computed. At this point, the receiver can select a position from the 20 possible bit boundary positions that maximizes bit energy. A maximum accumulated value at this position as well as offset accumulated values at 5 ms and 15 ms offset from the position can be determined. Then, the receiver can determine whether a ratio of at least one of the offset accumulated values to the maximum accumulated value meets a predetermined condition. When the ratio meets the predetermined condition, the receiver can output the position as the bit boundary of the GLONASS string.

### RELATED APPLICATIONS

The present application is related to U.S. patent application Ser. No. 12/______, entitled “HYBRID BIT EXTRACTION FOR GLOBAL POSITION RECEIVER”, filed by Atheros Communications, Inc. on Aug. ______, 2010, which is incorporated by reference herein.

### BACKGROUND OF THE INVENTION

1. Field of the Invention

The present invention relates to a global position receiver capable of receiving both GPS and GLONASS signals and in particular to detecting a GLONASS bit boundary.

2. Related Art

GPS (global positioning system) and GLONASS (global navigation satellite system) are radio-based satellite systems in operation today. To provide global coverage, GPS uses between 24-32 satellites. Assuming the minimum number of 24 satellites, 4 satellites are deployed in each of six orbits. The six orbital planes' ascending nodes are separated by 60 degrees. In this configuration, a minimum of six satellites should be in view from any given point at any time. To provide global coverage, GLONASS includes 24 satellites, wherein 21 satellites can be used for transmitting signals and 3 satellites can be used as spares. The 24 satellites are deployed in three orbits, each orbit having 8 satellites. The three orbital planes' ascending nodes are separated by 120 degrees. In this configuration, a minimum of five satellites should be in view from any given point at any time.

Both GPS and GLONASS broadcast two signals: a coarse acquisition (C/A code) signal and a precision (P code) signal. In general, global position devices, called receivers herein, lock onto the C/A transmission and not the P transmission. The P transmission is much longer than the C/A transmission and therefore is impractical to lock onto, e.g. by using synchronization. Once a lock is established via C/A transmission, the C/A transmission itself can provide a quick P lock.

The C/A codes for GPS, which can be generated as a modulo-2 sum of two maximum length shift register sequences, are selected for good cross-correlation properties. Each GPS satellite transmits its own unique C/A code, which has an identifiable pseudo-random noise code number (PRN#). In contrast, the C/A code for GLONASS is generated from a single maximum length shift register sequence, and each GLONASS satellite transmits the same C/A code, and is identified by its channel number (CHN#).

The C/A code includes navigation data, which provides information about the exact location of the satellite, the offset and drift of its on-board atomic clock, and information about other satellites in the system. In GPS, the C/A format for the navigation data includes words, frames, and sub-frames. The words are 30 bits long; ten words form one sub-frame; and five sub-frames form one frame. In GPS, the C/A code is 1023 bits long, is transmitted at 1.023 Mbps, and therefore has a repetition period of 1 ms. In GLONASS, the C/A format is strings, wherein each string includes 1.7 sec of navigation data and 0.3 sec of a time mark sequence. Notably, the C/A code in GLONASS is 511 bits long, is transmitted at 511 kbps, and therefore has the same code repetition period (i.e. 1 ms) as GPS.

Detection of the bit boundary of a GLONASS string and a GPS frame is critical for determining global positioning. Specifically, the timing information provided by each satellite is embedded in the string/frame. As indicated above, each bit of the string/frame is a predetermined length. Therefore, if the bit boundary is found, then the bits can be successfully decoded, thereby yielding the transmit time of that string/frame. At that point, by using a local clock time, the now known bit, and the transmit time, the travel time of the signal can be determined. Then, using the travel time, the distance and hence, global position of the receiver can be calculated.

Notably, even a small error in bit boundary detection can result in significant positioning error. For example, an error of 1 ms in the bit boundary can result in an error of 300 km in the measured distance from the satellite by the receiver. GLONASS poses significant challenges in achieving comparable positional accuracy to GPS. Therefore, a need arises for accurate bit boundary detection of GLONASS signals.

### SUMMARY OF THE INVENTION

A method of determining a bit boundary of a GLONASS string is provided. In this method, a global position receiver can remove the meander sequence from bits of a GLONASS signal. After removing the meander sequence, time averages of bit energies for 20 possible (consecutive) bit boundary positions can be computed. At this point, the receiver can select a position from the 20 possible bit boundary positions that maximizes bit energy. A maximum accumulated value at this position as well as offset accumulated values at 5 ms and 15 ms offset from the position can be determined. Then, the receiver can determine whether a ratio of at least one of the offset accumulated values to the maximum accumulated value meets a predetermined condition. When the ratio meets the predetermined condition, the receiver can output the position as the bit boundary of the GLONASS string.

In one embodiment, computing time averages is performed for a predetermined period, and the predetermined condition includes a threshold corresponding to the predetermined period. For example, when the predetermined period is 2 seconds, the threshold is 11/16; when the predetermined period is 4 seconds, the threshold is 13/16; when the predetermined period is 8 seconds, the threshold is 14/16; and when the predetermined period is 16 seconds, the threshold is 14/16.

In one embodiment, computing time averages can be performed for a first predetermined period, wherein the predetermined condition can then be based on a first threshold corresponding to the first predetermined period. When the ratio of at least one of the offset accumulated values to the maximum accumulated value does not meet the predetermined condition, then the receiver can continue to compute time averages for a second predetermined period, which includes the first predetermined period, wherein the predetermined condition can then be based on a second threshold corresponding to the second predetermined period. For example, when the first predetermined period is 2 seconds, the first threshold is 11/16; and when the second predetermined period is 4 seconds, the second threshold is 13/16.

In yet another embodiment, the method can further include after initial bit boundary detection, determining whether (a) the bit boundary correlates to an index value associated with a last bit synchronization, and (b) the bit boundary detection is not a first time detection. When (a) and (b) are true, then the receiver can output a new bit synchronization for receiver decoding and save the bit position as the index value. When (a) or (b) is not true, then the receiver can remain in a verify stage and additionally perform the bit boundary detection.

The 20 ms boundary detection can be divided into two steps: the detection of the 10 ms boundary, and the resolution of the ambiguity of which 10 ms boundary aligns with the 20 ms bit boundary. The second step includes determining offset accumulated values at 0 ms and 10 ms offsets from the position. When the ratio of the offset accumulated values passes a threshold, then a new bit synchronization can be output for receiver decoding.

Notably, the data used for performing the 20 ms boundary detection can depend on a carrier to noise ratio (CNo). When the CNo is strong (e.g. ≧29 dB-Hz), the 20 ms detection can use the same data used for the 10 ms detection. Therefore, in one embodiment, the 20 ms and the 10 ms can share the same accumulation buffer. When the CNo is medium strength, then the 20 ms boundary detection can include computing new time averages of bit energies for 20 new possible (consecutive) bit boundary positions. A new position can be selected from the 20 new possible bit boundary positions that maximizes bit energy. At this point, the 20 ms detection can be performed as described above. When the CNo is weak (e.g. <24 dB-Hz), then the receiver can start 20 ms detection after the 10 ms bit boundary detection is complete and a frequency error check is passed. In this case, the 20 ms detection can use newly accumulated data (similar to that described for a medium strength signal).

### BRIEF DESCRIPTION OF THE FIGURES

FIG. 1 illustrates an exemplary GLONASS receiver.

FIG. 2 illustrates the meandering sequence of the GLONASS signal as well as a comparison of the right bit boundary and an offset from that bit boundary.

FIG. 3A illustrates a graph of 20 ms integration values for a GPS signal plotted as a function of bit boundary error.

FIG. 3B illustrates a graph of 20 ms integration values for a GLONASS signal with a meander sequence plotted as a function of bit boundary error.

FIG. 4 illustrates a detection shape generated by removal of the meander sequence in a GLONASS signal.

FIG. 5A illustrates an exemplary technique for determining the bit boundary of a GPS frame.

FIG. 5B illustrates an exemplary GLONASS bit boundary detection technique that includes removing the meander sequence.

FIG. 6 illustrates a technique including multiple thresholds to balance detection time and detection probability.

FIG. 7 illustrates a GLONASS bit sync technique that can include a 10 ms boundary detection (described in reference to FIGS. 5B and 6), a verification stage, and a reset process for 20 no boundary (described below in reference to Table XX).

FIGS. 8A and 8B illustrate graphs that show performance results of GLONASS bit sync with multiple thresholds and a single threshold.

FIGS. 9A and 9B illustrate graphs that show performance results of GPS and GLONASS bit syncs with multiple thresholds and a single threshold.

FIGS. 10, 11, and 12 compare the simulated performance of 10 ms and 20 ms bit boundary detection for GLONASS.

### DETAILED DESCRIPTION OF THE FIGURES

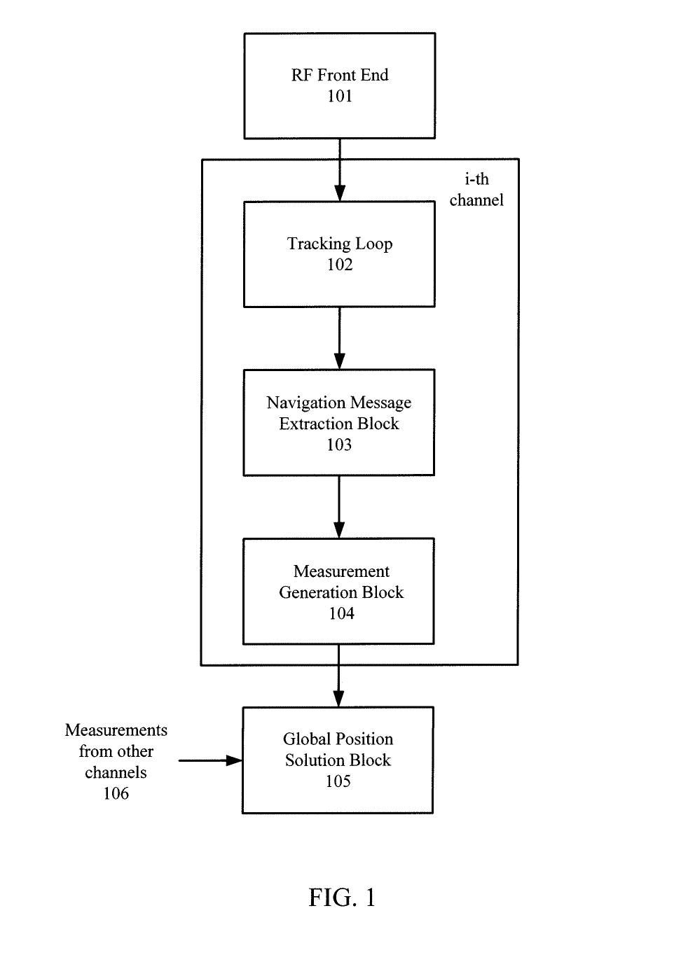

FIG. 1 illustrates an exemplary GLONASS receiver 100. In this simplified block diagram, GLONASS receiver 100 includes an RF front end 101 that down-converts GLONASS signals to a desired intermediate frequency and samples those down-converted signals at a predetermined sampling rate. These samples are then provided to a plurality of tracking channels in parallel, wherein only an i-th channel is shown for simplicity in FIG. 1. Each tracking channel includes a tracking loop 102, a navigation message block 103, and a measurement generation block 104. A global position solution block 105 receives the output of each channel to compute a navigation solution.

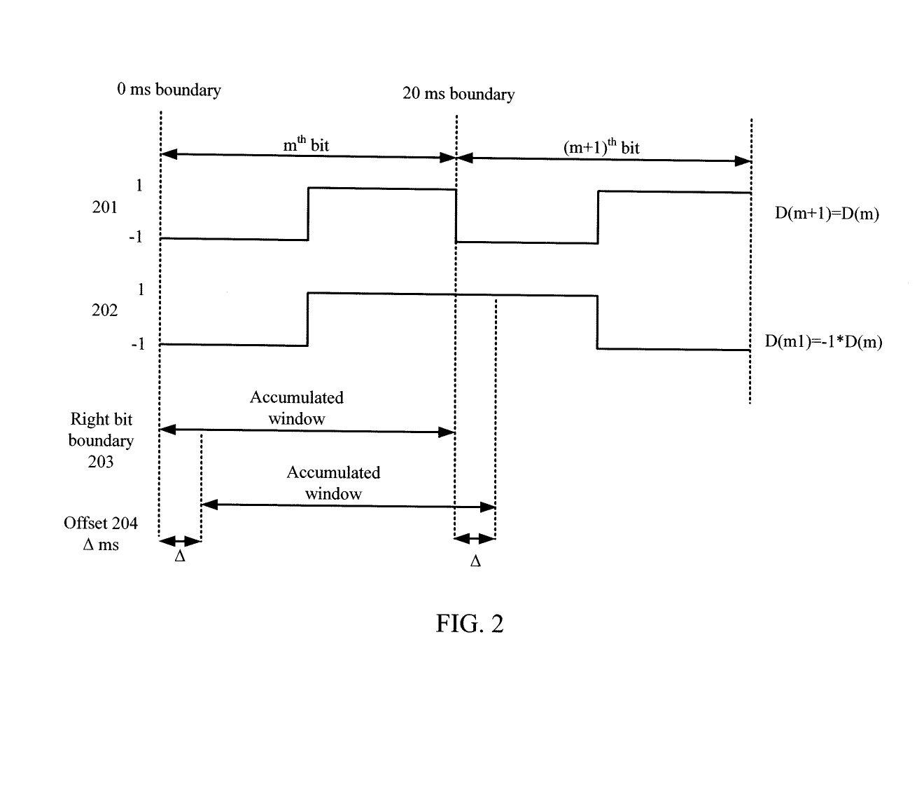

FIG. 2 illustrates exemplary bits (m^{th} and (m+1)^{th} bits) of a GPS signal 201 compared to those of a GLONASS signal 202. As shown, because of the meander of GLONASS signal 202, the (m+1)^{th} bit is inverted (i.e. D(m1)=−1*D(m)). GPS signal 201 and GLONASS signal 202 have corresponding accumulated window energies, which can vary based on an offset 204 as measured from a right (i.e. correct) bit boundary 203.

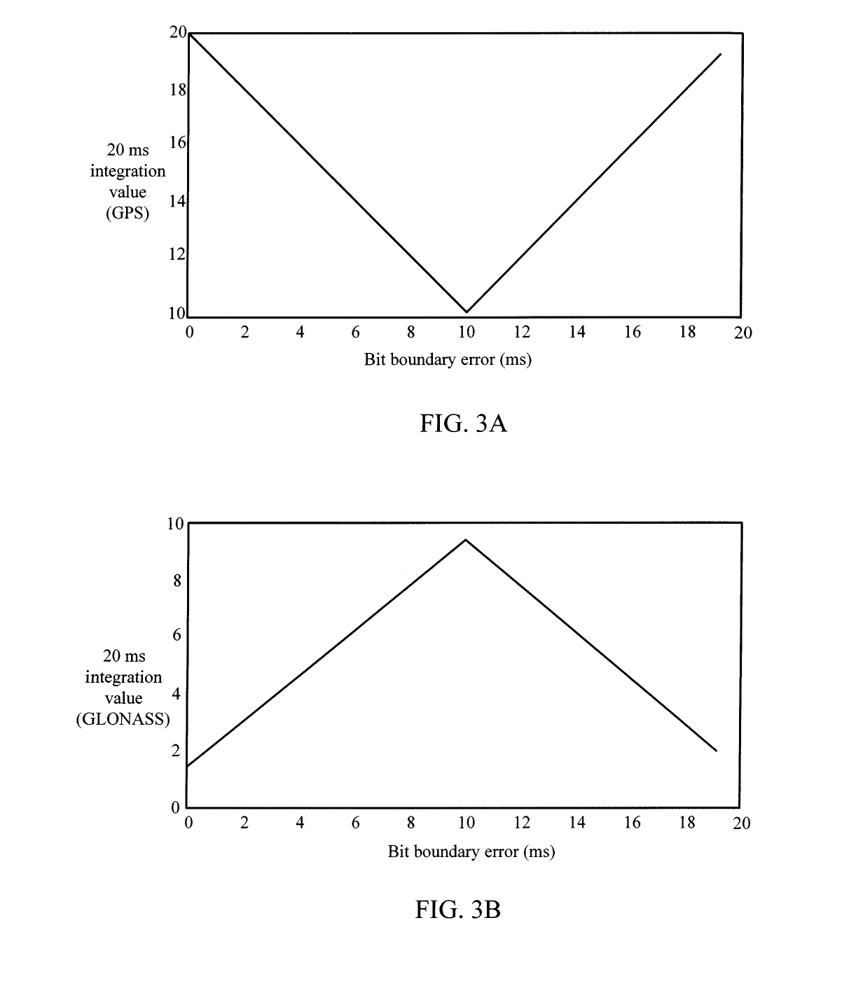

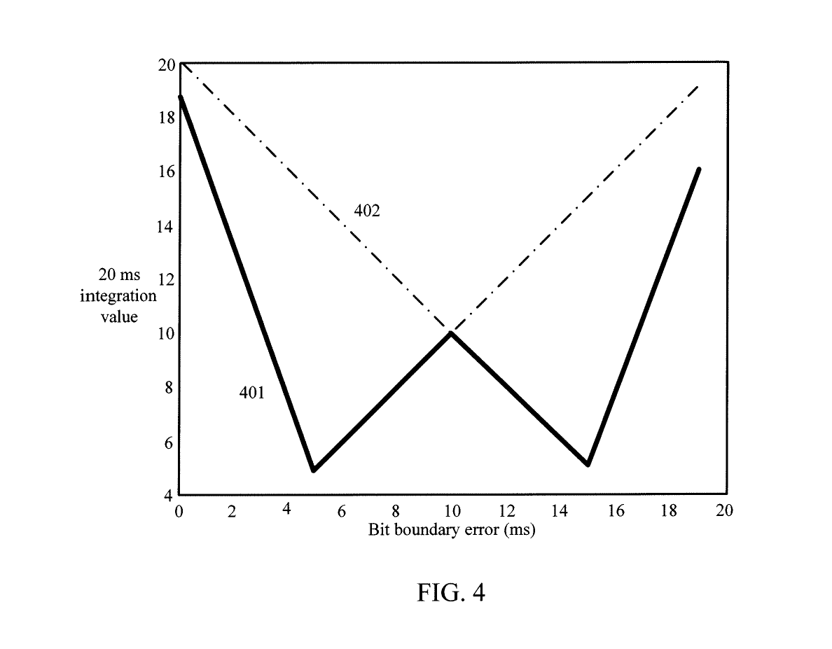

FIGS. 3A and 3B illustrate the accumulated window energies for GPS and GLONASS signals, respectively. Specifically, for a GPS signal (FIG. 3A), the GPS signal amplitude (accumulated value) is 20 and 10 for offsets of 0 and 10, respectively. That is, for a GPS signal there is a 50% chance that consecutive bits have the same sign. Therefore, the amplitude varies between 20 (consecutive bits having the same sign) and 10 (consecutive bits having different signs). In contrast, for a GLONASS signal (FIG. 3B) which includes the meandering of navigation bits for 1.7 sec and the time mark bits for 0.3 sec, the GLONASS signal amplitude is 2 and 10 for offsets of 0 and 10, respectively.

Thus, for a GPS signal 202, maximum energy is provided with right bit boundary 203 and minimum energy is provided when offset 204 is 10 ms. For GLONASS signal 202, because of its meandering sequence, minimum energy is provided with right bit boundary 203 and maximum energy is provided when offset 204 is 10 ms.

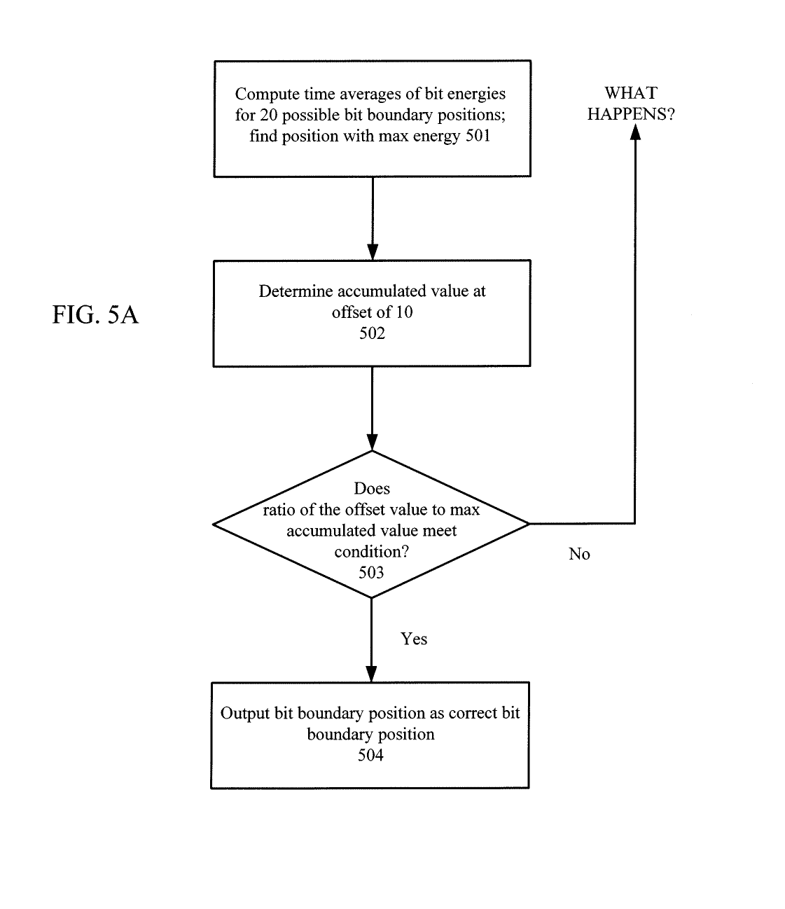

It logically follows from FIGS. 3A and 3B that the signal to noise ratio (SNR) for GLONASS is much weaker than that for GPS. Therefore, in one embodiment, to provide a stronger SNR for GLONASS signals, the meander sequence can be removed before summation (i.e. to generate the accumulated window energy). FIG. 4 illustrates a detection shape 401 generated by removal of the meander sequence in a GLONASS signal. Detection shape 401, which has a “W” formation, varies between approximately 19 and 5 during 0-10 ms, and between 5 and 16 during 10-20 ms. Note that a GPS “V” shape 402 is shown for context in FIG. 4. As shown by comparing shapes 401 and 402, removing the meander sequences [ones(1,10)-ones(1,10)] before summation in a GLONASS signal can result in the GLONASS signal providing better peak SNR than a GPS signal.

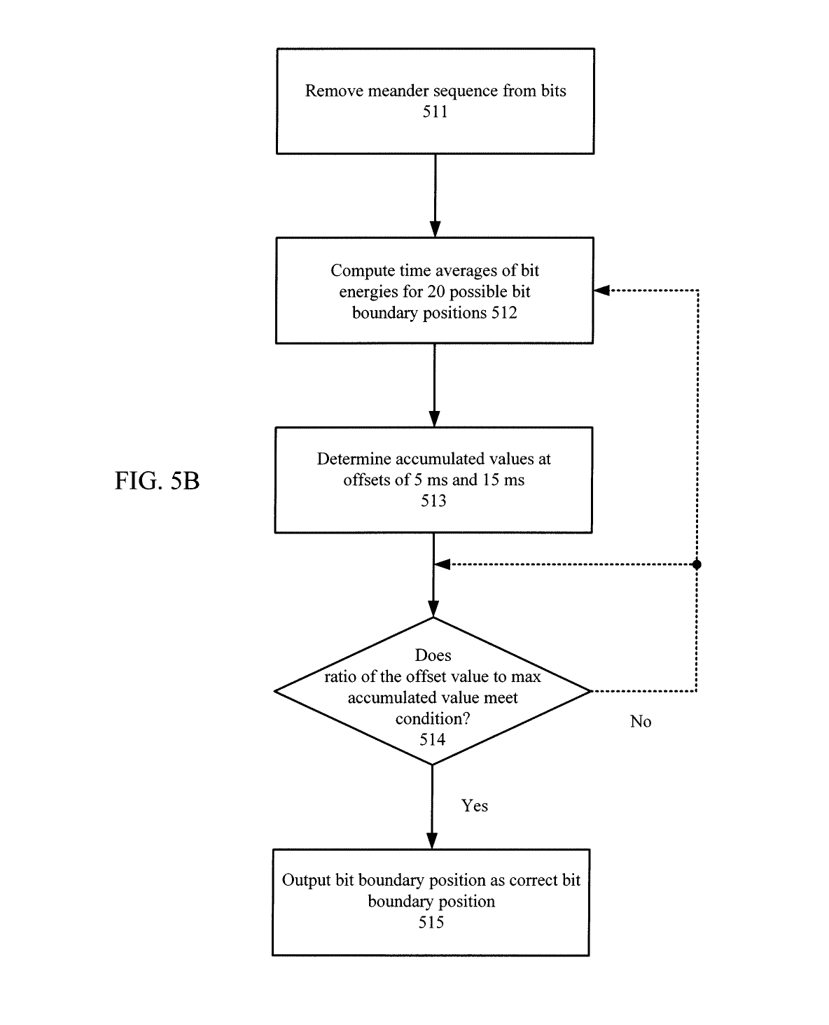

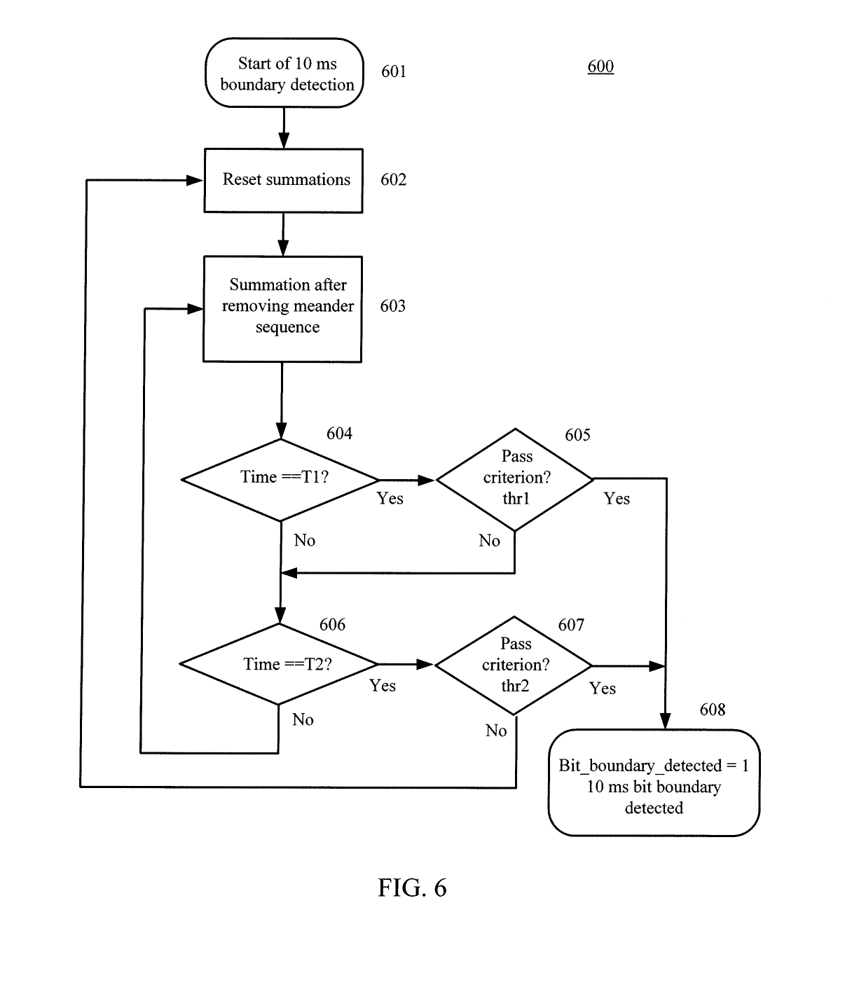

FIG. 5 illustrates an exemplary technique for detecting the right bit boundary of a GPS frame. Note that pseudo code below parallels the described steps of FIG. 5. Step 501 computes the time averages of bit energies for all 20 possible bit boundary positions and selects the position which maximizes the bit energy.

[dummy, ind]=max(w)

wherein [dummy, ind] is a function call, dummy is the first value (which is not needed) in a vector w, index (ind) indicates the offset, w is the vector (with 20 values in the context of bit boundary detection), and max(w) is the maximum value in the vector w.

In step 502, a circular shift of 10 ms (w_shift10) is performed on the vector w.

w_shift10=circshift(w, [10]); % circularly shift by 10 ms

In step 503, the shifted version can be divided by the original version (called a ratio), sample by sample (i.e. a dot division and specifically, a length 20 vector divided by another length 20 vector). The minimum ratio can then be determined.

[min_ratio, min_ratio_ind]=min(w shift 10./w);

If the present offset is indeed the right bit boundary, then the accumulated value at an offset of 10 ms period from the current bit boundary should be significantly smaller than the maximum due to different phase bits canceling each other. Therefore, in step 503, the ratio of the offset value to the maximum accumulated value can be checked to determine if the ratio is smaller than a predetermined threshold value.

If (min_ratio_ind==ind) & (min_ratio<threshold) % bit boundary detected with position=ind end

where==means “is the same as”.

Note that the predetermined threshold may depend on the estimation (accumulation) period, wherein optimized thresholds are 12/16, 13/16, 13/16, and 14/16 for 2, 4, 8, and 16 sec of estimation period, respectively. In one embodiment, the threshold is a programmable value that can be reset by the receiver.

If the condition is met at 10 ms, then that offset value can indicate the right boundary position, which can be output in step 504. The receiver can use this output to accurately decode the GPS signal, thereby facilitating accurate global positioning.

For GLONASS, removing the meander sequence before accumulation can facilitate determining the right bit boundary by increasing the SNR. However, as noted above, the right bit boundary may be falsely detected by a 10 ms offset (i.e. the maximum value will locate at the offset of 10 ms when suffering frequency offset error). FIG. 5B illustrates an exemplary GLONASS bit boundary detection technique that includes removing the meander sequence and also minimizing frequency offset error.

Step 511 removes the meander sequence from the bits. Step 512 then computes time averages of bit energies with [ones(1,10)-ones(1,10)] for all 20 possible bit boundary positions and selects the position which maximizes the bit energy.

[dummy, md]=max(w)

wherein as indicated above, [dummy, ind] is a function call, dummy is the first value in the vector (which is not needed), index (ind) indicates the offset, w is a vector with 20 values, and max(w) is the maximum value in that vector.

In step 513, circular shifts of 5 and 15 ms (w_shift05 and w_shift15) are performed on the vector w.

w_shift05=circshift(w, [1 05]); % circularly shift 5 ms

w_shift15=circshift(w, [1 15]); % circularly shift 15 ms

In step 514, the shifted version can be divided by the original version (called a ratio), sample by sample. The minimum ratio can then be determined.

[min_ratio05, min_ratio_ind05]=min(w_shift05./w)

[min_ratio15, min_ratio_ind15]=min(w_shift15./w)

If the tentative decision is correct, then the accumulated value at offsets of 5 ms and 15 ms from the current bit boundary should be significantly smaller than the maximum. Therefore, in step 514, the ratio of the offset values to the maximum accumulated value can be checked to determine if the ratios are smaller than a predetermined threshold value.

If ((min_ratio_ind05==ind) & (min_ratio05<threshold))∥((min_ratio_ind15==ind) & (min_ratio15<threshold)) % bit boundary detected with position=mod(ind, 10); end

Similarly to GPS, the predetermined threshold for GLONASS depends on the estimation period. In one embodiment, the optimized thresholds can be 11/16, 13/16, 14/16, and 14/16 for 2, 4, 8, and 16 sec of estimation period, respectively.

If the condition is met at either 5 ms or 15 ms, then that offset value can indicate the right boundary position, which can be output in step 515. That is, once either offset meets the condition, then the right boundary position can be easily derived from that offset. Moreover, once one offset meets the condition, the other offset is always 10 ms away and in accordance with detection shape 401 shown in FIG. 4, logically also meets the condition. Therefore, determining whether both offsets meet the condition is unnecessary. The receiver can use this output to accurately decode the GLONASS signal, thereby facilitating accurate global positioning.

Table 1 shows the detection probability for exemplary estimation (i.e. accumulation) periods of T=2 sec and T=4 sec. Note that the longer estimation period can allow choosing a looser threshold (i.e. a larger value) and also can result in higher detection probability. For a weak signal (as indicated by a smaller carrier to noise ratio, CNo), the longer estimation period (T=4 sec) outperforms the shorter estimation period (T=2 sec). For example, in the case of 18 dB-Hz of CNo, the detection probability of T=4 sec is more than double the detection probability of T=2 sec. In contrast, for a strong signal, the shorter estimation period (T=2 sec) is sufficient and leads to shorter detection time.

TABLE 4-1
Detection probability for different estimation
periods with optimal thresholds

| | Constant frequency error (Hz) | | | | |
|---|---|---|---|---|---|
| CNo | 0 | 5 | 10 | 15 | 20 |

Detection prob. for estimation period of 2 sec with
threshold = 11/16

| | | | | | |
|---|---|---|---|---|---|
| 18 dB-Hz | 0.378 | 0.356 | 0.22 | 0.084 | 0.02 |
| 21 dB-Hz | 0.999 | 1 | 0.984 | 0.898 | 0.543 |

Detection prob. for estimation period of 4 sec with
threshold = 13/16

| | | | | | |
|---|---|---|---|---|---|
| 18 dB-Hz | 0.999 | 0.999 | 0.998 | 0.959 | 0.741 |
| 21 dB-Hz | 1 | 1 | 1 | 1 | 1 |

Note that the thresholds can advantageously balance the success rate and false alarm rate (Pfa<=1e−3).

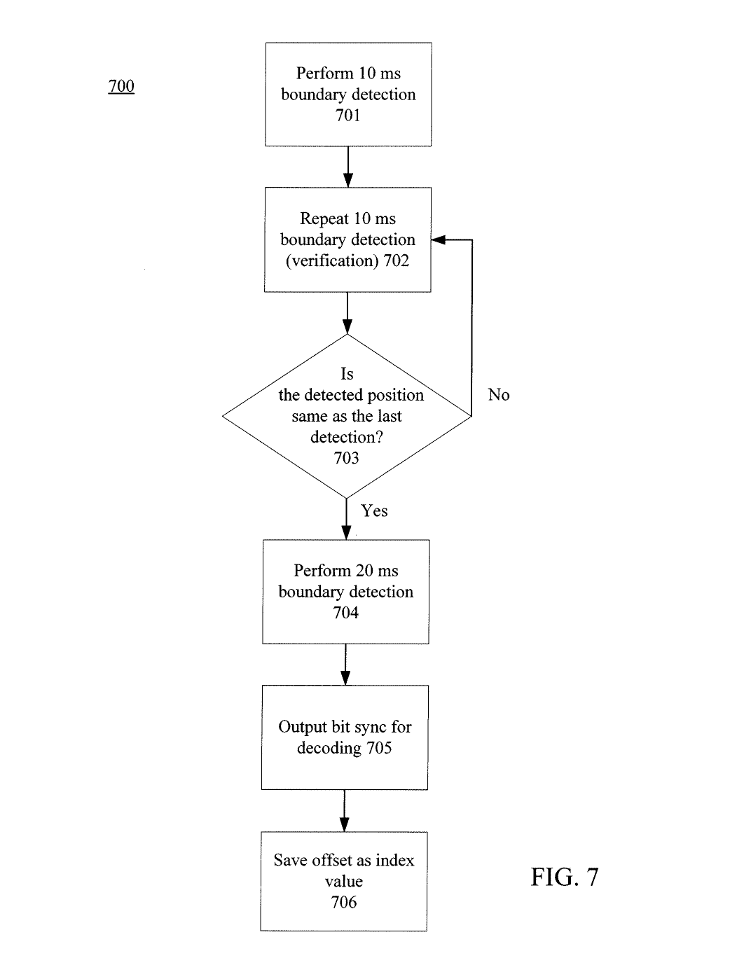

FIG. 6 illustrates a GLONASS bit boundary detection technique 600 including multiple thresholds to balance detection time and detection probability. Step 601 starts the 10 ms boundary detection technique described in reference to FIG. 5B. Step 602 can reset the summations. Step 603 can perform the summations after removing the meander sequence (steps 511 and 512, FIG. 5). Step 604 can determine at time T1 (e.g. 2 sec) whether the first pass criterion (i.e. the first predetermined threshold) is met in step 605. If the first pass criterion is met, then the bit boundary is characterized as being detected in step 608. If not, then step 606 can determine at time T2 (e.g. 4 sec) whether the second pass criterion (i.e. the second predetermined threshold) is met in step 607. If the second pass criterion is met, then the bit boundary is characterized as being detected in step 608. If not, then technique 600 can loop back to step 602 to reset summations and begin detection anew. Note that steps 604-607 are effectively included in step 514 (FIG. 5B, with loops returning to steps 512 or 513 depending on being T1 or T2). Further note that although times T1 and T2 are shown, additional or other times with associated predetermined thresholds can be included in other embodiments. In one embodiment, this multiple threshold technique can also be applied to GPS bit boundary detection (wherein step 603 is modified to delete the meander sequence removal).

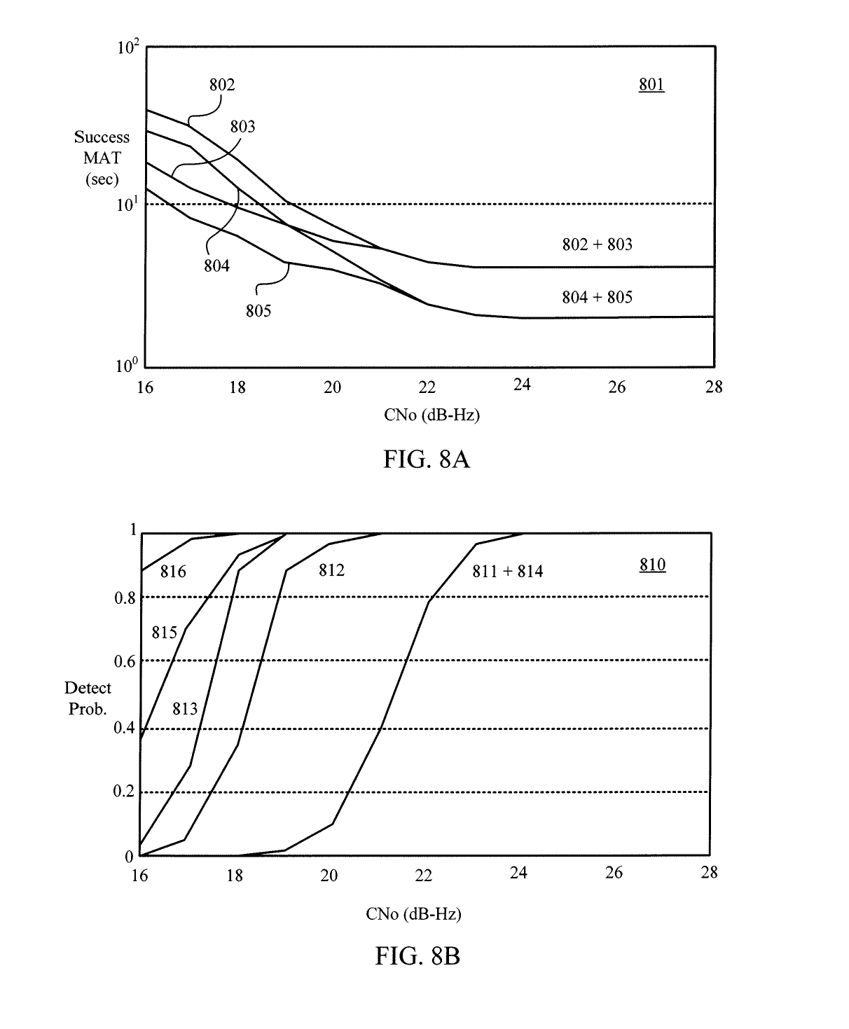

Because the bit boundary detection technique may be vulnerable to frequency offset error and subject to false detection, a verification stage can be used for GLONASS. FIG. 7 illustrates a GLONASS bit boundary detection technique 700 that includes a 10 ms boundary detection (described in reference to FIGS. 5B and 6) and a 20 ms boundary detection (described below in reference to Table 4). Step 701 can perform the 10 ms boundary detection, which is described in reference to FIG. 5B and FIG. 6 (optional), until the 10 ms bit boundary has been detected. At this point, step 702 can repeat the 10 ms bit boundary detection in a verification process. Step 703 can determine whether the detection position is verified or not. Bit synchronization can be verified if the position (702) is the same as the last detection (701). If bit synchronization is not verified, then technique 700 can return to step 702 to repeat the 10 ms boundary detection. If bit synchronization is verified in step 703, then step 704 can perform 20 ms boundary detection, as described in further detail below. Step 705 can output the newly found bit synchronization for receiver decoding. Step 706 can save the offset, i.e. the bit synchronization as an index value.

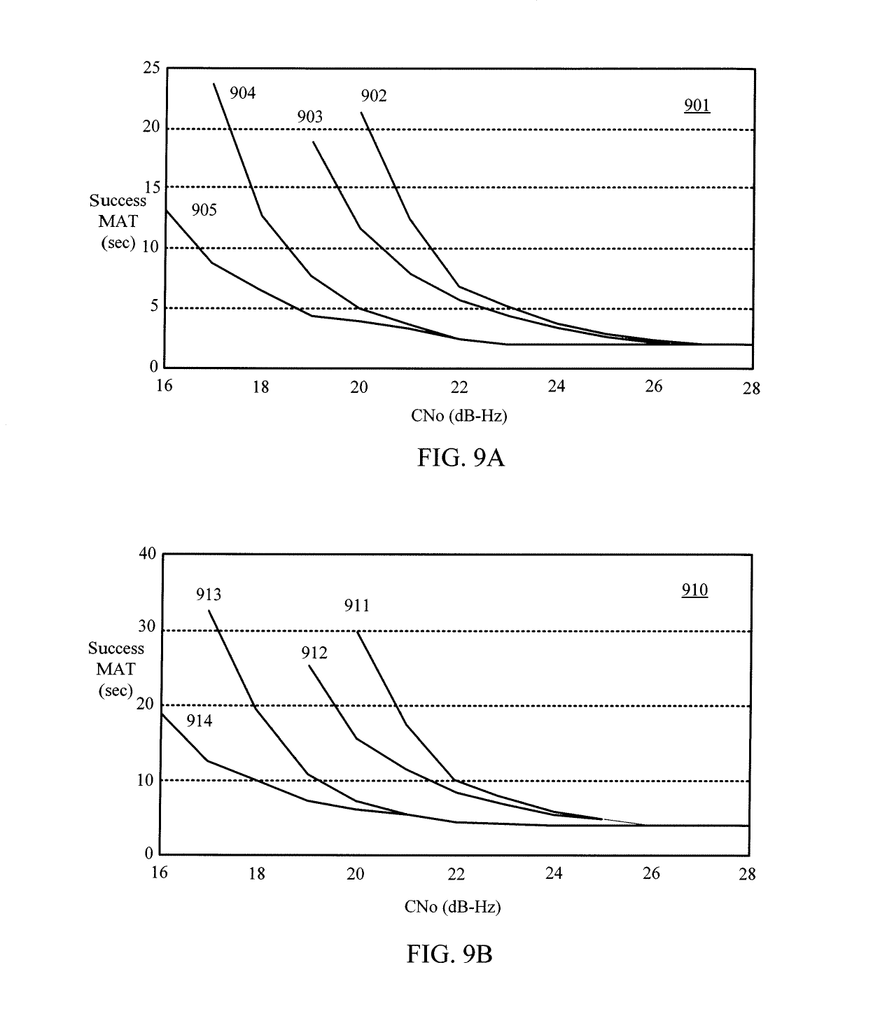

FIGS. 8A and 8B illustrate graphs 801 and 810, respectively, which show performance results of GLONASS bit sync with multiple thresholds and a single threshold. Specifically, graph 801 plots success MAT (mean acquisition time) versus CNo for single threshold detection (802), single threshold verification (803), multiple threshold detection (804), and multiple threshold verification (805). Graph 810 plots detection probability versus CNo for single threshold 5 sec detection (811), single threshold 15 sec detection (812), single threshold 30 sec detection (813), multiple threshold 5 sec detection (814), multiple threshold 15 sec detection (815), and multiple threshold 30 sec detection (816). Both graphs show simulated results assuming the following conditions: 30 Hz as an initial frequency error and 0 Hz/sec frequency acceleration as the impairment of the AFC. For the multiple thresholds technique, T1=2 sec (threshold=11/16) and T2=4 sec (threshold=13/16) were used. For the single threshold method, T=2 sec (threshold=11/16) was used.

As shown by FIGS. 8A and 8B, the GLONASS bit sync technique including multiple thresholds outperforms the single threshold technique. Moreover, for a weak GLONASS signal (e.g. under 20 dB-Hz), the multiple threshold technique gains 1-2 dB over the single threshold technique. For a strong GLONASS signal (e.g. over 22 dB-Hz), the two techniques have the same performance.

Table 2 shows that the GLONASS false alarm rate can be reduced to ‘zero’ (0/1000) by using the verification stage.

TABLE 2
GLO False alarm rate for first bit sync claim and
verified bit sync claim with timeout of 45 sec

| | |
|---|---|
| Bit sync detected | Bit sync verified |

| | Single | Multi- | Single | Multi- |
|---|---|---|---|---|
| CNo | threshold | threshold | threshold | threshold |
| 28-19 | 0 | 0 | 0 | 0 |
| dB-Hz | | | | |
| 18 | 1e−3 | 5e−3 | 0 | 0 |
| dB-Hz | | | | |
| 17 | 3e−3 | 7e−3 | 0 | 0 |
| dB-Hz | | | | |
| 16 | 2e−3 | 7e−3 | 0 | 0 |
| dB-Hz | | | | |

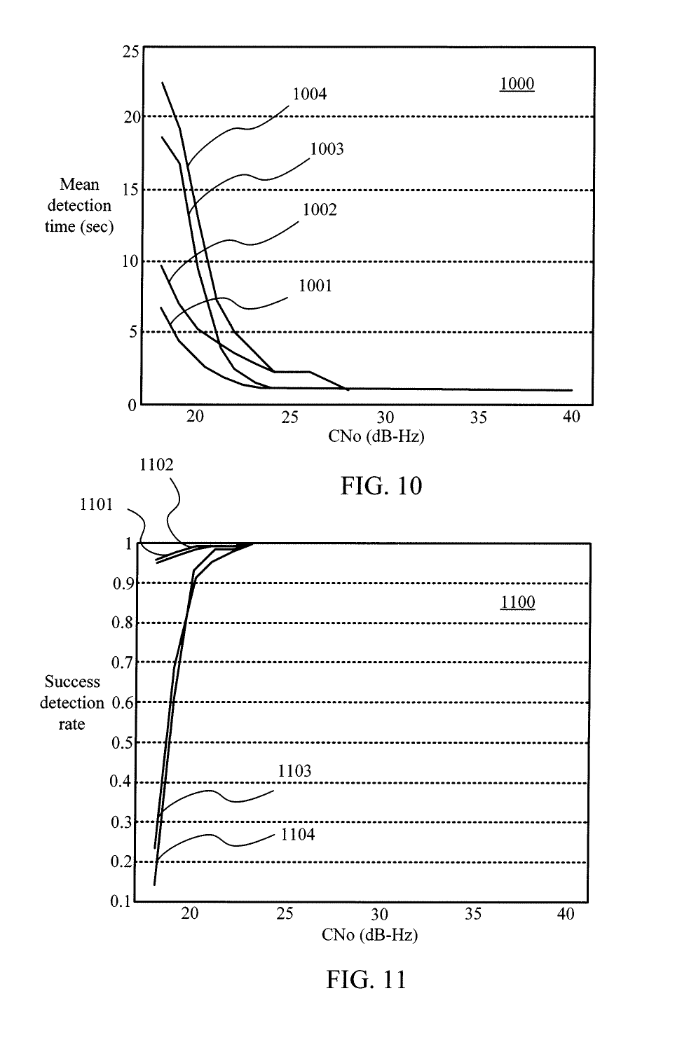

FIGS. 9A and 9B illustrate graphs 901 and 910, respectively, which show performance results of GPS and GLONASS bit syncs with multiple thresholds and a single threshold. Both graphs show simulated results assuming the following conditions: 30 Hz as an initial frequency error and 0 Hz/sec frequency acceleration as the impairment of the AFC. For the GLONASS multiple threshold technique, T1=2 sec (threshold=11/16) and T2=4 sec (threshold=13/16) were used. For the single threshold GLONASS technique, T=2 sec (threshold=11/16) was used. For the GPS multiple threshold technique, T1=2 sec (threshold=12/16) and T2=4 sec (threshold=13/16) were used. For the single threshold GPS technique, T=2 sec (threshold=12/16) was used.

Graph 901 plots success MAT versus CNo for single threshold GPS detection (902), multiple threshold GPS detection (903), single threshold GLONASS detection (904), and multiple threshold GLONASS detection (905). Graph 910 plots success MAT versus CNo for single threshold GPS verification (911), multiple threshold GPS verification (912), single threshold GLONASS verification (913), and multiple threshold GLONASS verification (914). As shown by FIGS. 9A and 9B, the bit sync performance for GLONASS is better than GPS by about 3 dB for both detection and verification.

Table 3 shows that the multiple threshold technique is also useful for reducing the false alarm rate in GPS bit sync.

TABLE 3
GPS false alarm rate for first bit sync claim and
verified bit sync claim with timeout of 45 sec

| | |
|---|---|
| Bit sync detected | Bit sync verified |

| | Single | Multi- | Single | Multi- |
|---|---|---|---|---|
| CNo | threshold | threshold | threshold | threshold |
| 28-24 | 0 | 0 | 0 | 0 |
| dB-Hz | | | | |
| 23 | 2e−3 | 3e−3 | 0 | 1e−3 |
| dB-Hz | | | | |
| 22 | 5e−3 | 6e−3 | 0 | 0 |
| dB-Hz | | | | |
| 21 | 9e−3 | 12e−3 | 0 | 3e−3 |
| dB-Hz | | | | |
| 20 | 6e−3 | 5e−3 | 0 | 0 |
| dB-Hz | | | | |
| 19 | 6e−3 | 6e−3 | 0 | 0 |
| dB-Hz | | | | |

Notably, a 20 ms bit boundary can be obtained using the result from the 10 ms bit boundary detection discussed above. In one embodiment, 20 ms bit boundary detection can check the values at 0 and 10 ms offset from the right bit boundary (found using 10 ms detection) to determine whether the boundary is “even” or “odd” (wherein consecutive bit boundaries can be numbered 1, 2, 3, . . . ). The 20 ms bit boundary can be declared as ‘ind’ (index) when the ratio w(mod(ind-1+10, 20)+1)/w(ind)<15/16 (wherein mod means modified).

Note that 20 ms detection may be more sensitive to AFC frequency error than 10 ms detection. Therefore, to protect 20 ms detection from large frequency error, 20 ms bit boundary detection can be started after 10 ms is detected so that a longer pre-detection interval is used, thereby reducing frequency error. Alternatively, 20 ms bit boundary detection can be started after frequency lock is detected by the existing frequency lock detector (e.g. PDI≧5 ms).

Table 4 shows a CNo-dependent technique for 20 ms bit boundary detection. As indicated, for a strong signal (e.g. ≧28 dB-Hz), 20 ms detection can be done using the same data used for 10 ms detection. Therefore, in one embodiment, both 10 and 20 ms detection can share the same accumulation buffer, and would as a result complete at the same time.

For a medium size signal (e.g. 24≦CNo≦28), 20 ms detection can start after 10 ms detection is done, i.e. the data is freshly accumulated. In this case, the data from both the 10 ms detection and the 20 ms detection can be compared, with the better detection result being chosen. Note that the frequency lock should be working by the end of the 10 ms detection and therefore (although not explicitly checked) the frequency error should be small in the 20 ms detection.

For a weak signal, 20 ms detection can also be started after 10 ms detection is done. Note that a large frequency error for a weak signal may cause the normally small mid-peak of the “W” formation to rise above one or both main side peaks. Therefore, particularly for detection using a weak signal, a frequency error check can also be performed before starting the 20 ms detection. Notably, performing this frequency error check can facilitate avoiding the use of a frequency-distorted signal during power energy accumulation, thereby reducing the false alarm rate.

TABLE 4
CNo-dependent GLONASS 20 ms bit
boundary detection technique.

| | CNo | | |
|---|---|---|---|
| Region | (dB-Hz) | Technique | Description |
| 1 | ≧28 | Combined | 20 ms detection share the same |
| | | detection | accumulation buffer as 10 ms |
| | | | detection; complete at the same |
| | | | time |
| 2 | 24 ≦ | Sequential | 20 ms detection starts after 10 |
| | CNo < 28 | detection | ms is detected. |
| 3 | <24 | Sequential | 20 20 ms detection starts after |
| | | detection + | 10 ms is detected, and frequency |
| | | frequency | error check is passed |
| | | error check | |

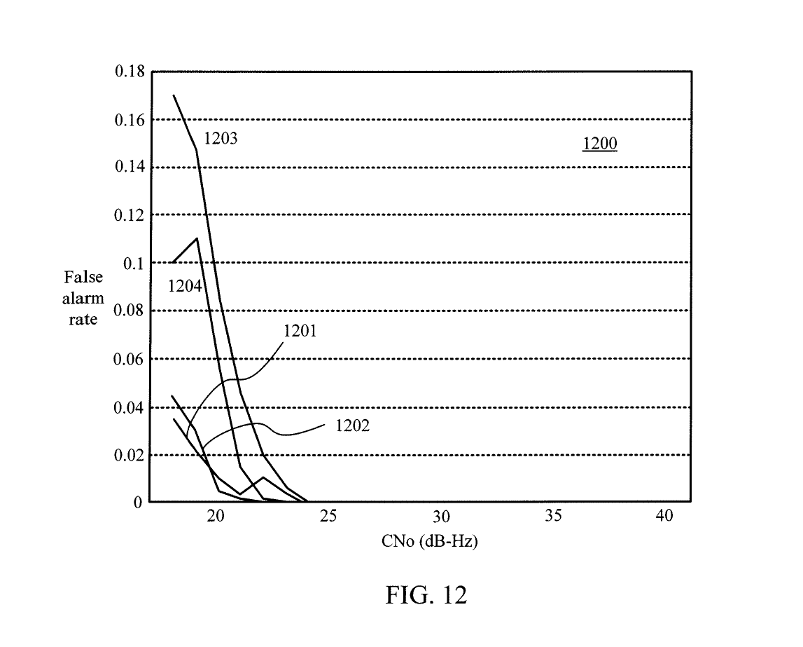

FIGS. 10, 11, and 12 compare the simulated performance of 10 ms and 20 ms bit boundary detection for GLONASS. To obtain these simulated results, the initial AFC frequency offset was set to a typical acquisition frequency error, and two acceleration values (i.e. 0 and 10 Hz/s) were considered. Note that the accumulation time was 1 sec, and the time out period was 30 sec.

FIG. 10 illustrates a graph 1000 that plots the mean detection time (sec) versus CNo for 10 ms boundary detection (0 Hz/s)(1001), 20 ms boundary detection (0 Hz/s)(1002), 10 ms boundary detection (10 Hz/s)(1003), and 20 ms boundary detection (10 Hz/s)(1004). FIG. 11 illustrates a graph 1100 that plots the success detection rate versus CNo for 10 ms boundary detection (0 Hz/s)(1101), 20 ms boundary detection (0 Hz/s)(1102), 10 ms boundary detection (10 Hz/s)(1103), and 20 ms boundary detection (10 Hz/s)(1104). FIG. 12 illustrates a graph 1200 that plots the false alarm rate versus CNo for 10 ms boundary detection (0 Hz/s)(1201), 20 ms boundary detection (0 Hz/s)(1202), 10 ms boundary detection (10 Hz/s)(1203), and 20 ms boundary detection (10 Hz/s)(1204). As shown by FIGS. 10, 11, and 12, 10 Hz/s acceleration significantly degrades performance of both 10 and 20 ms boundary detection unless a high CNo (e.g. over 20 dB-Hz) is available. Therefore, these results confirm that removing the meandering sequence (described above) to improve the signal to noise ratio can provide distinct advantages. Note that in the absence of acceleration, the results from 10 and 20 ms bit boundary detection are comparable.

The above-described GLONASS receiver can be implemented in digital electrical circuitry, or in computer hardware, firmware, software, or in combinations of them. For example, the GLONASS receiver can be implemented using a computer program product tangibly embodied in a machine-readable storage device for execution by a programmable processor; and method acts of the receiver can be performed by a programmable processor executing a program of instructions to perform global position functions by operating on input data and generating output data.

The receiver can be implemented advantageously in one or more computer programs that execute on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors, as well as other types of micro-controllers. Generally, a processor will receive instructions and data from a read-only memory and/or a random access memory. Generally, a computer will include one or more mass storage devices for storing data files; such devices include magnetic disks, such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices, magnetic disks such as internal hard disks and removable disks, magneto-optical disks, and CDROM disks. Any of the foregoing can be supplemented by, or incorporated in, application-specific integrated circuits (ASICs).

The embodiments described herein are not intended to be exhaustive or to limit the invention to the precise forms disclosed. As such, many modifications and variations will be apparent. For example, GLONASS 20 ms bit boundary detection can be alternatively obtained from time mark detection (that is, once the time mark boundary is determined, the even/odd designation of the boundary is known) or done independently. Accordingly, it is intended that the scope of the invention be defined by the following Claims and their equivalents.

1. A method of determining a bit boundary of a GLONASS string, the method comprising:
removing a meander sequence from bits of a GLONASS signal;
computing time averages of bit energies for 20 possible bit boundary positions after removing the meander sequence, the 20 possible bit boundary positions being consecutive positions;
selecting a position from the 20 possible bit boundary positions that maximizes bit energy;
determining a maximum accumulated value at the position;
determining offset accumulated values at a 5 ms offset from the position and a 15 ms offset from the position;
determining whether a ratio of at least one of the offset accumulated values to the maximum accumulated value meets a predetermined condition; and
when the ratio meets the predetermined condition, outputting the position as the bit boundary of the GLONASS string.

2. The method of claim 1, wherein computing time averages is performed for a predetermined period, and the predetermined condition includes a threshold corresponding to the predetermined period.

3. The method of claim 2, wherein the predetermined period is 2 seconds and the threshold is 11/16.

4. The method of claim 2, wherein the predetermined period is 4 seconds and the threshold is 13/16.

5. The method of claim 2, wherein the predetermined period is 8 seconds and the threshold is 14/16.

6. The method of claim 2, wherein the predetermined period is 16 seconds and the threshold is 14/16.

7. The method of claim 1, wherein computing time averages is performed for a first predetermined period, the predetermined condition then being based on a first threshold corresponding to the first predetermined period, and
when the ratio of at least one of the offset accumulated values to the maximum accumulated value does not meet the predetermined condition, then computing time averages for a second predetermined period, the predetermined condition then being based on a second threshold corresponding to the second predetermined period.

8. The method of claim 7, wherein the first predetermined period is 2 seconds and the first threshold is 11/16.

9. The method of claim 8, wherein the second predetermined period is 4 seconds and the second threshold is 13/16.

10. The method of claim 1, further including after bit boundary detection and before the outputting, determining whether (a) the bit boundary correlates to an index value associated with a last bit synchronization, and (b) the bit boundary detection is not a first time detection.

11. The method of claim 10, further including when (a) and (b) are true, then outputting a new bit synchronization for receiver decoding and saving the bit position as the index value.

12. The method of claim 10, further including when (a) or (b) is not true, then remaining in a verify stage and performing a 20 ms boundary detection.

13. The method of claim 12, wherein data for performing the 20 ms boundary detection depends on a carrier to noise ratio (CNo).

14. The method of claim 13, wherein when the CNo is weak, then the 20 ms boundary detection includes:
using data from computing the time averages of bit energies for the 20 possible bit boundary positions after removing the meander sequence;
determining offset accumulated values at a 0 ms offset from the position and a 10 ms offset from the position;
when a ratio of the offset accumulated values passes a threshold, then outputting a new bit synchronization for receiver decoding; and
saving the position as the index value.

15. The method of claim 13, wherein when the CNo is medium strength, then the 20 ms boundary detection includes:
computing new time averages of bit energies for 20 new possible bit boundary positions, the 20 new possible bit boundary positions being consecutive positions;
selecting a new position from the 20 new possible bit boundary positions that maximizes bit energy;
determining a maximum accumulated value at the new position;
determining offset accumulated values at a 0 ms offset from the new position and a 10 ms offset from the new position based on the new time averages;
when a ratio of the offset accumulated values passes a threshold, then outputting a new bit synchronization for receiver decoding; and
saving the new position as the index value.

16. The method of claim 13, wherein when the CNo is weak, then the 20 ms boundary detection includes:
computing new time averages of bit energies for 20 new possible bit boundary positions, the 20 new possible bit boundary positions being consecutive positions;
selecting a new position from the 20 new possible bit boundary positions that maximizes bit energy;
determining a maximum accumulated value at the new position;
determining offset accumulated values at a 0 ms offset from the new position and a 10 ms offset from the new position based on the new time averages;
when a ratio of the offset accumulated values passes a threshold and a frequency error check is passed, then outputting a new bit synchronization for receiver decoding; and
saving the new position as the index value.

17. A global position receiver configured to perform steps to determine a bit boundary of a GLONASS string, the steps comprising:
removing a meander sequence from bits of a GLONASS signal;
computing time averages of bit energies for 20 possible bit boundary positions after removing the meander sequence, the 20 possible bit boundary positions being consecutive positions;
selecting a position from the 20 possible bit boundary positions that maximizes bit energy;
determining a maximum accumulated value at the position;
determining offset accumulated values at a 5 ms offset from the position and a 15 ms offset from the position;
determining whether a ratio of at least one of the offset accumulated values to the maximum accumulated value meets a predetermined condition; and
when the ratio meets the predetermined condition, outputting the position as the bit boundary of the GLONASS string.

18. The global position receiver of claim 17, wherein computing time averages is performed for a predetermined period, and the predetermined condition includes a threshold corresponding to the predetermined period.

19. The global position receiver of claim 18, wherein the predetermined period is 2 seconds and the threshold is 11/16.

20. The global position receiver of claim 18, wherein the predetermined period is 4 seconds and the threshold is 13/16.

21. The global position receiver of claim 18, wherein the predetermined period is 8 seconds and the threshold is 14/16.

22. The global position receiver of claim 18, wherein the predetermined period is 16 seconds and the threshold is 14/16.

23. The global position receiver of claim 17, wherein computing time averages is performed for a first predetermined period, the predetermined condition then being based on a first threshold corresponding to the first predetermined period, and
when the ratio of at least one of the offset accumulated values to the maximum accumulated value does not meet the predetermined condition, then computing time averages for a second predetermined period, the predetermined condition then being based on a second threshold corresponding to the second predetermined period.

24. The global position receiver of claim 23, wherein the first predetermined period is 2 seconds and the first threshold is 11/16.

25. The global position receiver of claim 24, wherein the second predetermined period is 4 seconds and the second threshold is 13/16.

26. The global position receiver of claim 17, further including after bit boundary detection and before the outputting, determining whether (a) the bit boundary correlates to an index value associated with a last bit synchronization, and (b) the bit boundary detection is not a first time detection.

27. The global position receiver of claim 26, further including when (a) and (b) are true, then outputting a new bit synchronization for receiver decoding and saving the bit position as the index value.

28. The global position receiver of claim 26, further including when (a) or (b) is not true, then remaining in a verify stage and performing a 20 ms boundary detection.

29. The global position receiver of claim 28, wherein data for performing the 20 ms boundary detection depends on a carrier to noise ratio (CNo).

30. The global position receiver of claim 29, wherein when the CNo is weak, then the 20 ms boundary detection includes:
using data from computing the time averages of bit energies for the 20 possible bit boundary positions after removing the meander sequence;
determining offset accumulated values at a 0 ms offset from the position and a 10 ms offset from the position;
when a ratio of the offset accumulated values passes a threshold, then outputting a new bit synchronization for receiver decoding; and
saving the position as the index value.

31. The global position receiver of claim 29, wherein when the CNo is medium strength, then the 20 ms boundary detection includes:
computing new time averages of bit energies for 20 new possible bit boundary positions, the 20 new possible bit boundary positions being consecutive positions;
selecting a new position from the 20 new possible bit boundary positions that maximizes bit energy;
determining a maximum accumulated value at the new position;
determining offset accumulated values at a 0 ms offset from the new position and a 10 ms offset from the new position based on the new time averages;
when a ratio of the offset accumulated values passes a threshold, then outputting a new bit synchronization for receiver decoding; and
saving the new position as the index value.

32. The global position receiver of claim 29, wherein when the CNo is weak, then the 20 ms boundary detection includes:
computing new time averages of bit energies for 20 new possible bit boundary positions, the 20 new possible bit boundary positions being consecutive positions;
selecting a new position from the 20 new possible bit boundary positions that maximizes bit energy;
determining a maximum accumulated value at the new position;
determining offset accumulated values at a 0 ms offset from the new position and a 10 ms offset from the new position based on the new time averages;
when a ratio of the offset accumulated values passes a threshold and a frequency error check is passed, then outputting a new bit synchronization for receiver decoding; and
saving the new position as the index value.
